(19) United States
(12) Patent Application Publication
(10) Pub. No.: US 2026/0258693 A1
(43) Pub. Date: Sep. 3, 2026

(54) SLIDING DOOR INSERT FOR RETROFITTING A SLIDING DOOR IN A SLIDING DOOR CASSETTE OF AN EXPANDABLE SLIDING DOOR, SLIDING DOOR CASSETTE HAVING A SLIDING DOOR INSERT, AND RETROFITTING METHOD

(71) Applicant: INVENTIO AG, Hergiswil (CH)

(72) Inventor: Jonas Vonaesch, Luzern (CH)

(21) Appl. No.: 19/157,508

(22) PCT Filed: Feb. 1, 2024
(86) PCT No.: PCT/EP2024/052511

§ 371 Date: Aug. 18, 2025

(30) Foreign Application Priority Data
Feb. 21, 2023 (EP) 23157720.6

(51) Int. Cl. E06B 3/46; E06B 1/52

(52) U.S. Cl. CPC E06B 3/4654; E06B 1/52

(57) ABSTRACT

The present invention relates to a sliding door insert for retrofitting a sliding door in a sliding door cassette of an expandable sliding door, wherein the sliding door insert has a sliding door assembly and a panel set, wherein the sliding door assembly has a non-expandable sliding door leaf and is designed to be hooked into a guide rail of the sliding door cassette, wherein the panel set is designed to modify a frame of the sliding door cassette configured for the expandable sliding door, for the non-expandable sliding door leaf, wherein the panel set comprises a stop panel, a guide panel and a slot panel, wherein the stop panel is designed to be arranged on a stop side of the frame and to seal a stop side of the sliding door leaf, wherein the guide panel is designed to be arranged on a top side of the frame and to seal a top side of the sliding door leaf, and wherein the slot panel is designed to be arranged on a slot side of the frame and to seal a slot side of the sliding door leaf.

### FIELD

The present invention relates to a sliding door insert for retrofitting a sliding door in a sliding door cassette of an expandable sliding door, to a sliding door cassette for an expandable sliding door with a sliding door, and to a method for retrofitting a sliding door in a sliding door cassette of an expandable sliding door.

### BACKGROUND

An expandable sliding door can have movable half shells which are expanded in a frame of the sliding door when the sliding door is closed and are each brought into contact with seals on the frame in order to seal the sliding door to the frame. To open the sliding door, the half shells are drawn together to make the sliding door thinner and to be able to slide into a slot next to the frame.

The frame for such an expandable sliding door can be pre-installed during the construction of a building, without having to install the expandable sliding door. The frame can then be used in different ways until there is a need for the expandable sliding door. For example, the frame can be paneled and form a passage without a door, or a shelving system can be arranged in the passage and close off the passage.

Likewise, a particularly single sliding door can be hooked into a guide rail of the frame. The particularly single sliding door cannot be expanded and cannot change its thickness. The particularly single sliding door can serve as a privacy screen, as it cannot seal against the frame seals for the expandable sliding door. A non-expandable sliding door can also be synonymously referred to as a constant thickness sliding door.

For example, WO 2023/274674 A1 describes a multifunctional building wall module system.

### SUMMARY

There is a need, among other things, for a sliding door insert for retrofitting a sliding door in a sliding door cassette of an expandable sliding door with improved properties, in particular, for example, a soundproof seal.

Such a need can be met by a sliding door insert for retrofitting a sliding door in a sliding door cassette of an expandable sliding door, a sliding door cassette for an expandable sliding door with a sliding door, and a method for retrofitting a sliding door in a sliding door cassette of an expandable sliding door according to the advantageous embodiments defined and described herein.

In the approach presented here, a non-expandable sliding door leaf is hooked into an existing guide for an expandable sliding door and a frame configured for the expandable sliding door is supplemented by additional panels. The panels cover a gap between the non-expandable sliding door leaf and a contour of the frame designed for the expandable sliding door leaf, so that the non-expandable sliding door leaf can seal via seals on the panels or the panels can seal via seals on the sliding door leaf.

The approach presented here allows the closed single sliding door to provide particularly good sound insulation, as air gaps around the sliding door are closed by contacting seals.

According to a first aspect of the invention, a sliding door insert for retrofitting a sliding door cassette of an expandable sliding door with a sliding door is disclosed. The sliding door insert has a sliding door assembly and a panel set. The sliding door assembly has a non-expandable sliding door leaf and is designed to be hooked into a guide rail of the sliding door cassette. The panel set is designed to modify a frame of the sliding door cassette configured for the expandable sliding door, for the non-expandable sliding door leaf. The panel set comprises a stop panel, a guide panel, and a slot panel. The stop panel is designed to be arranged on a stop side of the frame and to seal a stop side of the sliding door leaf. The guide panel is designed to be arranged on a top side of the frame and to seal a top side of the sliding door leaf. The slot panel is designed to be arranged on a slot side of the frame and to seal a slot side of the sliding door leaf. The guide panel has at least one lowerable seal for sealing the top side.

According to a second aspect of the invention, a sliding door cassette for an expandable sliding door with a sliding door is disclosed, wherein the sliding door cassette comprises a sliding door insert according to the first aspect of the invention. A non-expandable sliding door leaf of a sliding door assembly of the sliding door insert is hooked into a guide rail of the sliding door cassette and a panel set of the sliding door insert modifies a frame of the sliding door cassette for the non-expandable sliding door leaf. A stop panel of the panel set is arranged on a stop side of the frame and seals a stop side of the sliding door leaf. A guide panel of the panel set is arranged on a top side of the frame and seals a top side of the sliding door leaf. A slot panel of the panel set is arranged on a slot side of the frame and seals a slot side of the sliding door leaf.

According to a third aspect of the invention, a method for retrofitting a sliding door cassette of an expandable sliding door with a sliding door with a sliding door insert is disclosed according to the first aspect of the invention, wherein a non-expandable sliding door leaf of the sliding door assembly of a sliding door insert is hooked into a guide rail of the sliding door cassette. A frame of the sliding door cassette configured for the expandable sliding door is modified using a panel set of the sliding door insert for the sliding door leaf. A stop panel of the panel set is arranged on a stop side of the frame in order to seal a stop side of the sliding door leaf. A guide panel of the panel set is arranged on a top side of the frame in order to seal a top side of the sliding door leaf. A slot panel of the panel set is arranged on a slot side of the frame in order to seal a slot side of the sliding door leaf.

A sliding door cassette may be a wall structure prepared to receive an expandable sliding door, having a passageway closable by the sliding door and a slot adjacent to the passageway for receiving the opened sliding door. The passage is surrounded by a frame of the sliding door cassette. The slot and the passage are connected by at least one guide rail of the sliding door cassette. The sliding door cassette can be installed in a wall of a building to provide the option of installing a particularly expandable sliding door. The slot is arranged in a cavity between a wall paneling. Preferably, the cavity is 125 mm wide and the side paneling on both sides is 12.5 mm thick, so that a wall thickness of 150 mm is achieved.

The expandable sliding door has a mechanism that influences the distance between two half shells of the sliding door. To open the sliding door, the half shells are drawn together by the mechanism, their distance is reduced and the sliding door is thus thinner. In the thin state, the sliding door is moved along the guide rail into the slot and opens the passage. The expandable sliding door is usually electrically driven. The expandable sliding door can substantially disappear completely into the slot.

To close the expandable sliding door, the drawn-together half shells are moved along the guide rail out of the slot into the passage, and are expanded in the passage by the mechanism when a stop side of the sliding door has reached a stop side of the frame. When expanded, the distance between the half shells is increased until the half shells seal against the seals of the frame over the entire periphery. By expanding them, the seals can be compressed and ensure a good seal of the passage.

In the approach presented here, the sliding door cassette for the expandable sliding door is retrofitted with a single, non-expandable sliding door. The non-expandable sliding door is retrofitted as a sliding door insert and the frame is modified so that the single sliding door is also sealed with seals. The non-expandable sliding door has in particular a one-piece sliding door leaf.

The sliding door insert is made up of multiple parts and is assembled in a sequence. A sliding door assembly can be provided pre-assembled. A panel set can be provided as individual parts.

The sliding door assembly can comprise all components that are attached to the sliding door leaf or are at least partially movable with the sliding door leaf. The sliding door assembly may have at least two guides for hanging in the guide rail. The guides can in particular be roller guides that can roll in the guide rail. The guides can be arranged on a top side and/or guide side of the sliding door leaf and, in particular, can be connected to the sliding door leaf in a height-adjustable manner in order to be able to align the sliding door leaf relative to the guide rail. The guides can be hooked into the guide rail. After hanging, the guides can be concealed by side panels of the sliding door leaf. The sliding door assembly may also comprise a drive mechanism to move the sliding door leaf back and forth between a closed position and an open position. The sliding door assembly may comprise a locking mechanism for locking the sliding door leaf at least in the closed position.

The panel set can have one or more matching panels for each side of the frame. The different sides of the frame can be referred to as the stop side, the guide side and the slot side. The different sides of the frame can therefore be modified using single-piece or multi-piece panels. In particular, the guide panel and the slot panel can each be made up of two parts, since a gap for the non-expandable sliding door leaf is formed between two parts of the panels. In the gap, the non-expandable sliding door leaf is moved back and forth between the passage and the slot when opening and closing. The stop panel can be one piece.

The panel set may have seals that seal against the sealing surfaces of the sliding door leaf. Alternatively or additionally, the sliding door leaf can have seals that seal against the sealing surfaces of the panel set.

A lowerable seal can be a movable, controllable seal. The lowerable seal can assume a raised state or a lowered state. In the raised state, the lowerable seal can be lifted from a surface of the sliding door leaf and not touch the sliding door leaf. In the lowered state, the lowerable seal can rest on the surface of the sliding door leaf and seal against the sliding door leaf. The lowerable seal can be controlled electrically or mechanically, for example via a control cam. The lowerable seal can be installed in any direction and can, for example, be moved upwards or to the side to create a seal. In particular, the guide panel can have two lowerable seals. The seals can seal on opposite sealing surfaces of the sliding door leaf, i.e., on the inside and outside of the sliding door leaf.

The stop panel, the slot panel and/or the sliding door assembly can have seal receptacles for the original seals of the frame. To modify the frame, the original seals of the frame can be removed and arranged at least on the stop panel, the slot panel and/or the sliding door leaf.

A seal receptacle can, for example, be a profiled groove. A foot of the original seal can be inserted into the seal receptacle and mechanically interlocked or elastically clamped in the seal receptacle. The original seals can be used, as they already have the correct dimensions. The seal receptacles can be arranged in pairs symmetrically about a center plane of the sliding door insert. Then the original seals can seal on both sides of the sliding door.

The seal receptacles can be arranged on the sliding door leaf, particularly on the slot side. Then the original seals can only come into contact with their sealing surfaces on the slot panel directly when the sliding door is closed, preventing grinding of the original seals on the sliding door leaf.

As an alternative to the original seals, other seals can also be used.

Alternatively, the sliding door assembly may comprise at least one liftable seal for sealing against the guide panel. The liftable seal can substantially correspond to a lowerable seal. The liftable seal can be located on the top side of the sliding door leaf. The liftable seal can extend upwards to seal against a sealing surface of the guide panel.

The sliding door assembly may have at least one lowerable seal for sealing at the floor. The lowerable seal can be arranged on the underside of the sliding door leaf. The lowerable seal can use the floor under the sliding door as a sealing surface. The lower, lowerable seal can have an increased range of motion. This prevents the lowerable seal from grinding against uneven surfaces or dirt on the floor.

At least the stop panel and/or the slot panel can be designed to be attached in the original seal receptacles of the frame. The stop panel and/or the slot panel can be mechanically interlocked in the seal receptacles. Likewise, the stop panel and/or the slot panel can be clamped into the seal receptacles and/or magnetically attached to the edge profiles of the frame that have the seal receptacles. By attaching it to the original seal receptacles, the panel set can be installed on the frame without permanent modification and removed again without leaving any residue. In particular, the panel set can be installed without tools.

The sliding door assembly may comprise a drive to move the sliding door leaf back and forth between a closed position and an open position. The drive can be arranged on the slot side of the sliding door leaf and can be designed to be arranged within a slot of the sliding door cassette. A drive may comprise an electric motor. The electric motor can, for example, engage a toothed rack on the guide rail via a gearwheel. The drive can also have a belt running over pulleys, which is moved by the electric motor relative to the sliding door leaf. Either the sliding door leaf can be coupled to the belt and the electric motor can be coupled to the guide rail or the belt can be coupled to the guide rail and the electric motor can be coupled to the sliding door leaf. The drive can be discreetly integrated into the sliding door assembly within the slot and can be protected within the slot.

The sliding door assembly can have a controller. The controller can be located on the slot side of the sliding door leaf. The controller can be located in the region of the drive. The controller can be discreetly integrated into the sliding door assembly within the slot and can be protected within the slot.

The stop panel and at least part of the stop side of the frame can be removable. The sliding door cassette may have a maintenance pocket behind the stop panel and the stop side for receiving at least a portion of the sliding door leaf. When the stop panel is installed in the slot of the sliding door cassette, components of the sliding door assembly that are normally hidden can be accessed if the sliding door leaf is at least partially arranged in the maintenance pocket. To service the sliding door insert, the stop panel and at least part of the stop side of the frame can be removed to make the maintenance pocket arranged behind the stop panel and the stop side accessible for receiving at least a portion of the sliding door leaf. The sliding door leaf can be arranged at least partially in the maintenance pocket in order to make components of the sliding door assembly that would otherwise be hidden in the slot accessible for maintenance when the stop panel is installed.

A maintenance pocket can be an additional, lockable slot opposite the slot. The maintenance pocket can be arranged in a cavity between the paneling of the sliding door cassette. The guide rail can extend into the maintenance pocket. The sliding door leaf can be moved so far into the maintenance pocket that the components of the sliding door assembly that would otherwise be inaccessible in the slot, such as the drive and controller, are located in the passage and are therefore accessible.

The maintenance pocket can also be used when installing the sliding door assembly. For example, the stop side of the sliding door leaf can be placed in the maintenance pocket first and then the slot side can be aligned with the guide rail. The guides of the sliding door assembly can also be coupled to the guide rail in this order. When the sliding door assembly is hooked into the guide rail, the sliding door assembly can be moved from the maintenance pocket into the slot and the maintenance pocket can be closed by the stop side and the slot panel.

It should be noted that some of the possible features and advantages of the invention are described herein with reference to different embodiments of methods on the one hand and of devices on the other. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

FIG. 1 is a view of a sliding door cassette for an expandable sliding door with a built-in sliding door insert according to an embodiment; and

FIGS. 2a to 2d are detailed views of a sliding door insert according to an embodiment.

The figures are merely schematic and not true to scale. The same reference signs indicate the same or equivalent features.

### DETAILED DESCRIPTION

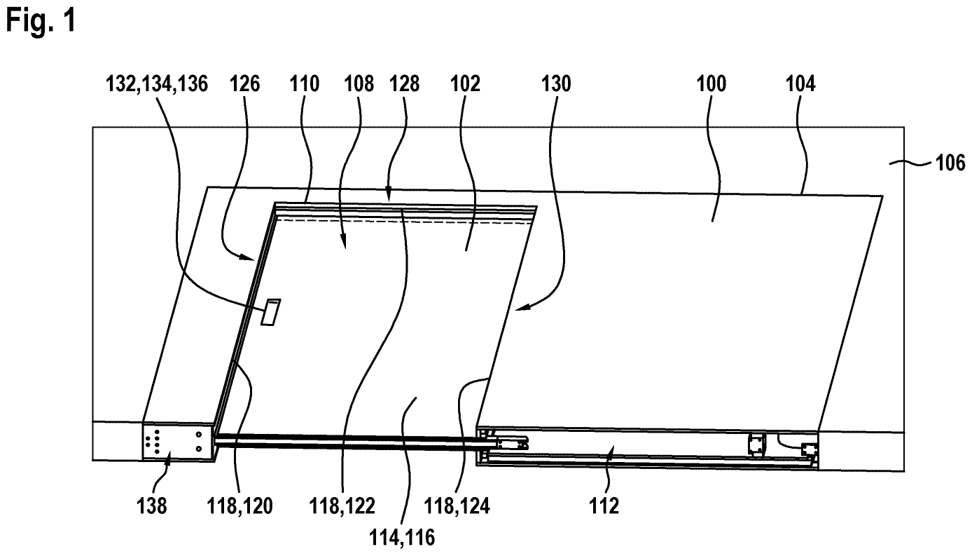

FIG. 1 is a view of a sliding door cassette 100 for an expandable sliding door with a built-in sliding door insert 102 according to an embodiment. The sliding door cassette 100 is arranged in an opening 104 of a wall 106 of a building (not shown). The sliding door cassette 100 is constructed as a drywall construction with paneled studs on both sides and completely closes off the opening 104 except for a door-shaped passage opening 108 through the wall 106. The passage opening 108 is framed by a frame 110 of the sliding door cassette 100. The frame 110 is designed to close and seal the passage opening 108 in conjunction with the expandable sliding door which is expanded in the closed state. For this purpose, the expandable sliding door is pressed from the inside against the surrounding seals or sealing surfaces of the frame 110 when it is expanded. Next to the passage opening 108, a slot 112 of the sliding door cassette 100 is arranged in the stud frame between the paneling on both sides. The slot 112 is designed to receive the non-expanded, expandable sliding door in the open state, so that the expandable sliding door virtually disappears into the wall 106. A horizontal guide rail for the expandable sliding door runs along a top side of the passage opening 108 and a top side of the slot 112. The guide rail runs in a notch of a top side of the passage opening 108.

The sliding door insert 102 is installed in this case instead of the expandable sliding door. The sliding door insert 102 has a sliding door assembly 114 with a non-expandable sliding door leaf 116 and a panel set 118. The sliding door leaf 116 is one piece. The sliding door assembly 114 is attached to the guide rail and the non-expandable sliding door leaf 116 is hooked into the guide rail. Since the non-expandable sliding door leaf 116 has the same thickness in the closed and open state, it is recessed behind a plane of the paneling on both sides of the sliding door cassette 100 in the closed state and cannot seal directly against the seals or sealing surfaces of the frame 110. Therefore, the panel set 118 is installed in the frame and has seals or sealing surfaces that match the non-expandable sliding door leaf 116.

The panel set 118 is at least three-part and consists of a stop panel 120, a guide panel 122 and a slot panel 124. The stop panel 120 is arranged on a stop side 126 of the frame 110. The guide panel 122 is arranged on a top side 128 of the frame 110. The slot panel 124 is arranged on a slot side 130 of the frame 110. The panel set 118 bridges gaps between the seals or sealing surfaces of the frame 110 and the non-expandable sliding door leaf 116.

In one embodiment, the sliding door assembly 114 has an electric drive for the sliding door leaf 116. The drive is arranged on the slot side of the sliding door leaf 116 and is arranged within the slot 112 during normal operation of the sliding door insert 102. The drive can be attached to the sliding door leaf 116 and coupled to the guide rail, for example, via a belt. Likewise, the drive can be coupled directly to the guide rail and, for example, coupled to the sliding door leaf 116 via a belt. The drive can open and close the sliding door leaf 116 automatically. The drive allows the sliding door leaf 116 to be retracted into the slot 112 flush with the frame 110 and/or the slot panel 124 and does not require a handle.

In one embodiment, the sliding door assembly 114 further comprises a drive controller. By virtue of the integrated controller, the sliding door insert 102 can be delivered ready to plug in, is easy to install, and only requires a power supply. The controller can be installed on the drive and thus disappears in the slot 112 of the sliding door cassette 100.

In one embodiment, the sliding door leaf 116 has a control contour 132. The sliding door insert 102 can be controlled via the control contour. The control contour 132 may be touch-sensitive and may also have a display 134. For example, an image of a door camera 136 integrated into the control contour 132 on an outer side can be displayed via the display 134. The image can, for example, be provided automatically when the doorbell is rung via the control contour 132.

In one embodiment, the sliding door cassette 100 has a maintenance pocket 138 on a side opposite the slot 112, which, like the slot 112, is arranged between the paneling of the stud frame on both sides. The guide rail extends into the maintenance pocket 138. During normal operation, the maintenance pocket 138 is closed off by the stop side 126 of the frame 110. When the expandable sliding door or the non-expandable sliding door assembly 114 is to be serviced, the stop side 126 is at least partially removed or at least a portion of the stop side 126 and the stop panel 120 are removed and the maintenance pocket 138 is opened. Then the non-expanded sliding door or the sliding door leaf 116 can be moved at least partially into the maintenance pocket 138. This makes components of the sliding door assembly 114 accessible which are arranged within the slot 112 during normal operation and are therefore inaccessible.

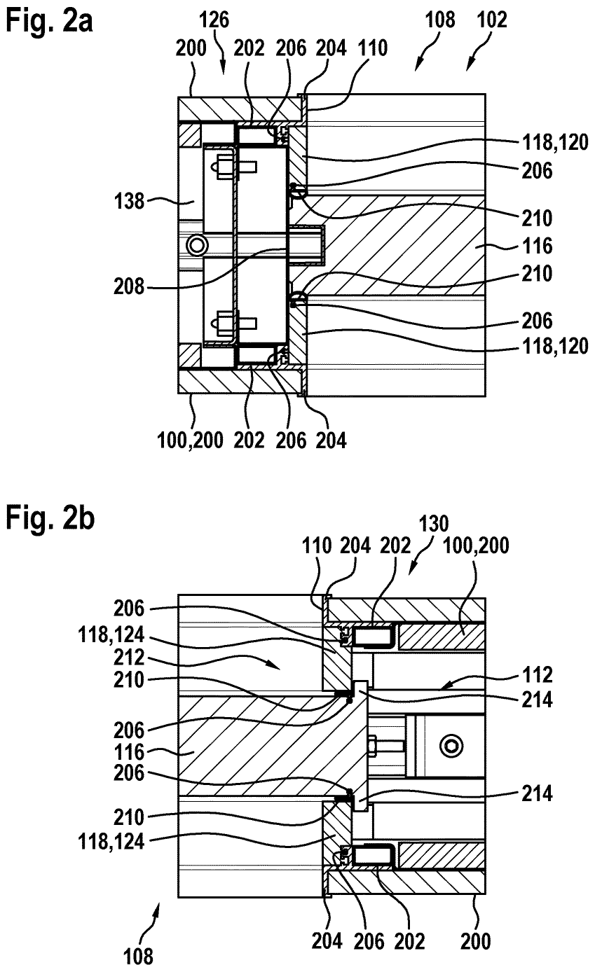

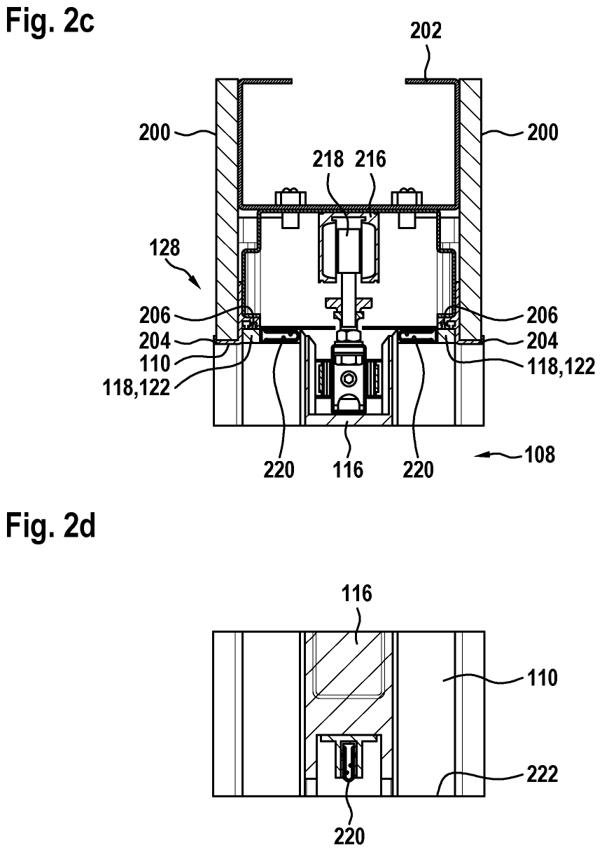

FIGS. 2a to 2d show detailed views of a sliding door insert 102 according to an embodiment. The sliding door insert 102 substantially corresponds to the sliding door insert 102 in FIG. 1. FIGS. 2a, 2b and 2c show the panels 120, 122, 124 of the panel set 118 in sectional views through the frame 110. FIG. 2d shows a sectional view through an underside of the non-expandable sliding door leaf 116.

In FIG. 2a, the stop side 126 of the frame 110 is shown in horizontal section. As in FIG. 1, a view from below is shown. The sliding door cassette 100 has the paneling 200 on an inner side and an outer side. The stud frame 202 is arranged in a gap between the paneling 200. Edge profiles 204 are attached to the stud frame 202. The edge profiles 204 each enclose an edge of the paneling 200 facing the passage opening 108 in order to protect the edge from damage. The edge profiles 204 have seal receptacles 206 for seals of the expandable sliding door. The seal receptacles 206 are formed as recesses in a profile cross section of the edge profiles 204 and are arranged set back behind the edge. A stop profile 208 is arranged between the edge profiles 204. The stop profile 208 is also set back behind the edges of the paneling 200 and closes off the gap between the paneling 200.

In one embodiment, the stop profile 208 is removable to make the maintenance pocket 138 in the gap accessible.

In this case, the stop panel 120 of the panel set 118 is arranged in front of the stop profile 208. The stop panel 120 modifies the stop side 126 for the non-expandable sliding door leaf 116. The stop panel 120 forms a receiving space for the sliding door leaf 116. The stop panel 120 fills a gap between the edges of the paneling 200 and the non-expandable sliding door leaf 116. The sliding door leaf 116 moves during the closing process into a recess formed by the stop panel 120 and, in the closed state, seals off the stop panel 120 via at least one contacting seal. For example, the seal can be a lip seal. The seal can be arranged on the stop panel 120 and seal against a sealing surface of the sliding door leaf 116. Alternatively, the seal can be arranged on the sliding door leaf 116 and seal against a sealing surface of the stop panel 120.

In one embodiment, the stop panel 120 has two seal receptacles 206 for original seals 210 of the sliding door cassette 100. The seal receptacles 206 are formed as recesses in a profile cross section of the stop panel 120. The original seals 210 can be removed from the seal receptacles 206 of the edge profiles 204 before installing the stop panel 120 and inserted into the seal receptacles 206 of the stop panel 120. Alternatively, the original seals 210 can be supplied with the sliding door insert 102.

In one embodiment, the stop panel 120 is attached to the seal receptacles 206 of the edge profiles 204. For example, the stop panel 120 can be positively snapped into the seal receptacles 206 via snap elements. Alternatively, the stop panel 120 can be clamped into the seal receptacles 206 via clamping elements. The stop panel 120 can also be held to the edge profiles 204 by magnets.

In FIG. 2b, the slot side 130 of the frame 110 is shown in horizontal section. As in FIG. 2a, a view from below is shown. The slot side 130 substantially corresponds to the stop side 126 and has the substantially similar edge profiles 204 on the edges of the paneling 200 facing the passage opening 108 with the seal receptacles 206, as well as the stud frame 202 paneled on the outer side and inner side of the sliding door cassette 100 with the gap therebetween. The gap between them forms the slot 112. In contrast to the view in FIG. 2a, an opening 212 of the slot 112 is arranged between the edge profiles 204.

The slot panel 124 modifies the slot side 130 for the non-expandable sliding door leaf 116, reduces the opening 212 to a width suitable for the non-expandable sliding door leaf 116 and seals via at least two contacting seals on the sliding door leaf 116. The seals can be lip seals, for example. The seals can be arranged on the slot panel 124 and seal on the sealing surfaces of the sliding door leaf 116. Alternatively, the seals can be arranged on the sliding door leaf 116 and seal on the sealing surfaces of the slot panel 124.

The slot panel 124 is in two parts, with one part of the slot panel 124 being arranged on the inner side of the sliding door leaf 116 and the other part of the slot panel 124 being arranged on the outer side of the sliding door leaf 116. One of the seals is arranged between each part and the sliding door leaf 116.

In one embodiment, the seals are arranged on the sliding door leaf 116. For this purpose, the sliding door leaf 116 has two seal receptacles 206 for original seals 210 of the sliding door cassette 100. The seal receptacles 206 are formed as recesses in a profile cross section of the sliding door leaf 116. The original seals 210 can be removed from the seal receptacles 206 of the edge profiles 204 before installing the slot panel 124 and inserted into the seal receptacles 206 of the sliding door leaf 116. Alternatively, the original seals 210 can be supplied with the sliding door insert 102.

In one embodiment, the sliding door leaf 116 has a widening 214 at its end arranged in the slot 112. The widening 214 is wider than the opening 212 modified by the slot panel 124. The seal receptacles 206 are arranged directly in front of the widening 214. Thus, the widening 214 serves as a support surface for the seals 210.

In one embodiment, the parts of the stop panel 120 are attached to the seal receptacles 206 of the edge profiles 204. For example, the parts can be positively snapped into the seal receptacles 206 via snap elements. Alternatively, the parts can be clamped into the seal receptacles 206 via clamping elements. The parts can also be held to the edge profiles 204 using magnets.

In FIG. 2c, the top side 128 of the frame 110 is shown in vertical section. The top side 128 substantially corresponds to the stop side 126 and the slot side 130 and has the substantially similar edge profiles 204 on the edges of the paneling 200 facing the passage opening 108 with the seal receptacles 206, as well as the stud frame 202 paneled on the outer side and inside of the sliding door cassette 100 with the gap therebetween. In contrast to the view in FIGS. 2a and 2b, the horizontal guide rail 216 of the sliding door cassette 100 is arranged in the gap between them. The guide rail 216 is attached to a cross member of the stud frame 202.

The non-expandable sliding door leaf 116 is movably mounted in the guide rail 216 via roller running gear 218. The roller running gear 218 is connected to the sliding door leaf 116 between two extensions of the outer side and the inner side of the sliding door leaf 116 in a resulting recess on a top side of the sliding door leaf 116. The guide panel 122 modifies the top side 128 of the frame 110 for the non-expandable sliding door leaf 116 and seals the sliding door leaf 116 via at least two seals. The seals can be arranged on the guide panel 122 and seal on the sealing surfaces of the sliding door leaf 116. Alternatively, the seals can be arranged on the sliding door leaf 116 and seal on the sealing surfaces of the guide panel 122.

The guide panel 122 is in two parts, with one part of the guide panel 122 being arranged on the inner side of the sliding door leaf 116 between the edge profile 204 and the sliding door leaf 116 and the other part of the guide panel 122 being arranged on the outer side of the sliding door leaf 116 between the edge profile 204 and the sliding door leaf 116. One of the seals is arranged between each part and the sliding door leaf 116. The extensions of the outer and inner sides project between the parts of the guide panel 122.

In one embodiment, the seals are lowerable seals 220. The lowerable seals 220 are driven by an actuator. The lowerable seals 220 are controlled by the controller of the sliding door insert 102. The lowerable seals 220 are raised from the sealing surfaces and do not touch the sealing surfaces when the sliding door leaf 116 is moved along the guide rail 216. At least when the passage opening 108 is closed off, the lowerable seals 220 are placed on the sealing surfaces and then seal against the sealing surfaces.

In one embodiment, the lowerable seals are horizontally movable and arranged on the guide panel 122. The sealing surfaces are arranged on the extensions of the outer side and the inner side of the sliding door leaf 116.

In one embodiment, the parts of the guide panel 122 are attached to the seal receptacles 206 of the edge profiles 204. For example, the parts can be positively snapped into the seal receptacles 206 via snap elements. Alternatively, the parts can be clamped into the seal receptacles 206 via clamping elements. The parts can also be held to the edge profiles 204 using magnets.

In FIG. 2d, a lower edge of the non-expandable sliding door leaf 116 is shown in vertical section. There is no panel of the panel set 118 on the lower edge. The sliding door leaf 116 has a recess in an underside in which a lowerable seal 220 is arranged. The lowerable seal 220 seals the frame 110 against the floor 222 in the lowered state. The lowerable seal 220 is raised from the floor 222 when the sliding door leaf 116 moves along the guide rail 216.

In the following, possible embodiments of the invention are summarized again or presented using slightly different wording.

A single sliding door for the cassette of a collapsable door is presented.

The inexpensive, non-expandable sliding door is particularly soundproof and has an electric drive. The sliding door has no manual door handle and can be retracted into the wall flush with the door frame by virtue of the electric drive.

Paneling on the door frame closes off the opening, which is actually too large for the collapsable door. The paneling is easy to remove.

The sliding door is provided as a set to complement a cassette for an expandable sliding door assembly. The set comprises a non-expandable door and a panel set. A first subset of the panel set covers the opening into which the sliding door moves when opened and is designed to accommodate seals. A second subset of the panel set covers the receiving space into which the sliding door moves when closing and is designed to accommodate seals. A third subset of the panel set covers the region at the top of the sliding door into which the sliding door retracts when closing, and has lowerable seals.

The door can have one, preferably two, lowerable seals at the bottom.

The first subset and/or the second subset can be attached to the seal receptacles of the cassette using positively fitting snap elements, magnets or clamping elements. The seals are removed beforehand.

The first subset is in two parts, with one part on the inside and one part on the outside of the sliding door. The second subset is one-piece, i.e., connected at least at the top.

The sliding door is preferably designed as a single body. A drive is attached to the end of the door that remains in the cassette. A controller is also attached to the end of the door that remains in the cassette.

The sliding door can have control contours, touchscreens on the inside of the door and/or a peephole camera.

To convert or retrofit a cassette with such a sliding door, the four vertical seals are removed if present. The vertical seals already have the correct length. Furthermore, the two horizontal seals are removed if present.

Then, the first subset and the second subset are preferably attached to the profile used to attach the seals, and the previously removed vertical seals are attached to the paneling. Finally, the third panel is attached.

For maintenance purposes, the second paneling can be removed along with the end piece underneath and the sliding door can be moved into the service space so that work can be carried out on the drive and controller at the rear.

Finally, it should be noted that terms such as “having,” “comprising,” etc. do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1.-12. (canceled)

13. A sliding door insert for retrofitting a sliding door cassette of an expandable sliding door with a sliding door, the sliding door insert comprising:
a sliding door assembly, wherein the sliding door assembly includes a non-expandable sliding door leaf and is designed to be hooked into a guide rail of the sliding door cassette; and
a panel set designed to modify a frame of the sliding door cassette configured for the expandable sliding door for the sliding door leaf, wherein the panel set comprises a stop panel, a guide panel, and a slot panel, wherein the stop panel is designed to be arranged on a stop side of the frame and to seal a stop side of the sliding door leaf, wherein the guide panel is designed to be arranged on a top side of the frame and to seal a top side of the sliding door leaf, wherein the slot panel is designed to be arranged on a slot side of the frame and to seal a slot side of the sliding door leaf, and wherein the guide panel includes at least one lowerable seal for sealing the top side of the frame.

14. The sliding door insert according to claim 13, wherein at least the stop panel, the slot panel, and/or the sliding door assembly have seal receptacles for original seals of the frame.

15. The sliding door insert according to claim 13, wherein the sliding door assembly includes at least one liftable seal for sealing against the guide panel.

16. The sliding door insert according to claim 13, wherein the sliding door assembly includes at least one lowerable seal to seal against a floor.

17. The sliding door insert according to claim 13, wherein at least the stop panel and/or the slot panel is designed to be attached in original seal receptacles of the frame.

18. The sliding door insert according to claim 13, wherein the sliding door assembly includes a drive for the sliding door leaf, and wherein the drive is arranged on the slot side of the sliding door leaf and is designed to be arranged within a slot of the sliding door cassette.

19. The sliding door insert according to claim 13, wherein the sliding door assembly includes a controller, the controller being arranged on the slot side of the sliding door leaf.

20. A sliding door cassette for an expandable sliding door, having a sliding door, the sliding door cassette comprising:
a sliding door insert including a sliding door assembly and a panel set, wherein a non-expandable sliding door leaf of the sliding door assembly of the sliding door insert is hooked into a guide rail of the sliding door cassette, and the panel set of the sliding door insert modifies a frame of the sliding door cassette for the sliding door leaf, wherein a stop panel of the panel set is arranged on a stop side of the frame and seals a stop side of the sliding door leaf, wherein a guide panel of the panel set is arranged on a top side of the frame and seals a top side of the sliding door leaf, and wherein a slot panel of the panel set is arranged on a slot side of the frame and seals a slot side of the sliding door leaf.

21. The sliding door cassette according to claim 20, wherein the stop panel and at least a part of the stop side of the frame are removable, wherein the sliding door cassette has a maintenance pocket behind the stop panel and the stop side for receiving at least a portion of the sliding door leaf, and wherein, when the stop panel is installed, components of the sliding door assembly hidden in a slot of the sliding door cassette are accessible when the sliding door leaf is at least partially arranged in the maintenance pocket.

22. A method for retrofitting a sliding door cassette of an expandable sliding door having a sliding door, the method comprising:
providing a sliding door insert including a sliding door assembly and a panel set, wherein a preferably non-expandable sliding door leaf of the sliding door assembly of the sliding door insert is hooked into a guide rail of the sliding door cassette, wherein a frame of the sliding door cassette configured for the expandable sliding door s modified using the panel set of the sliding door insert for the sliding door leaf, wherein a stop panel of the panel set is arranged on a stop side of the frame to seal a stop side of the sliding door leaf, wherein a guide panel of the panel set is arranged on a top side of the frame to seal a top side of the sliding door leaf, and wherein a slot panel of the panel set is arranged on a slot side of the frame to seal a slot side of the sliding door leaf.

23. The method according to claim 22, wherein, to modify the frame, original seals of the frame are removed and arranged at least on the stop panel, the slot panel, and/or the sliding door leaf.

24. The method according to claim 22, wherein, for servicing the sliding door insert, the stop panel and at least a part of the stop side of the frame are removed to make a maintenance pocket arranged behind the stop panel and the stop side accessible for receiving at least a portion of the sliding door leaf, and wherein the sliding door leaf is arranged at least partially in the maintenance pocket to make components of the sliding door assembly hidden in a slot of the slot side accessible for servicing when the stop panel is installed.
